(19) United States
(12) Patent Application Publication
(10) Pub. No.: US 2026/0166993 A1
(43) Pub. Date: Jun. 18, 2026

(54) MEANS OF LOCOMOTION HAVING A FOLDABLE OR ROLLABLE DISPLAY

(71) Applicant: Bayerische Motoren Werke Aktiengesellschaft, Muenchen (DE)

(72) Inventors: Daniel Bartoschek, Unterschleissheim (DE); Christian Denich, Muenchen (DE); Benjamin Quattelbaum, Minato Ku (JP); Christina Grasser, Muenchen (DE)

(21) Appl. No.: 18/712,134

(22) PCT Filed: Oct. 20, 2022
(86) PCT No.: PCT/EP2022/079330

§ 371 Date: May 21, 2024

(30) Foreign Application Priority Data
Nov. 30, 2021 (DE) 10 2021 131 343.0

(51) Int. Cl. B60K 35/22; B60K 35/29; B60K 35/53; B60K 35/55; B60R 11/00

(52) U.S. Cl. CPC B60K 35/223; B60K 35/29; B60K 35/53; B60K 35/55; B60K 2360/1868; B60R 2011/0082

(57) ABSTRACT

A means of locomotion is disclosed herein. The means of locomotion includes a base and a foldable or rollable display. The base is arranged in an interior surface of the means of locomotion and holds the display. The base includes a lifting unit for lowering the display in the surface of the interior, or holding the display rigidly or in such a way that it can be turned. The display is adapted to turn a first portion from a first relative position in relation to a second portion into a second relative position and to vary a representation content automatically in response to the second position being reached.

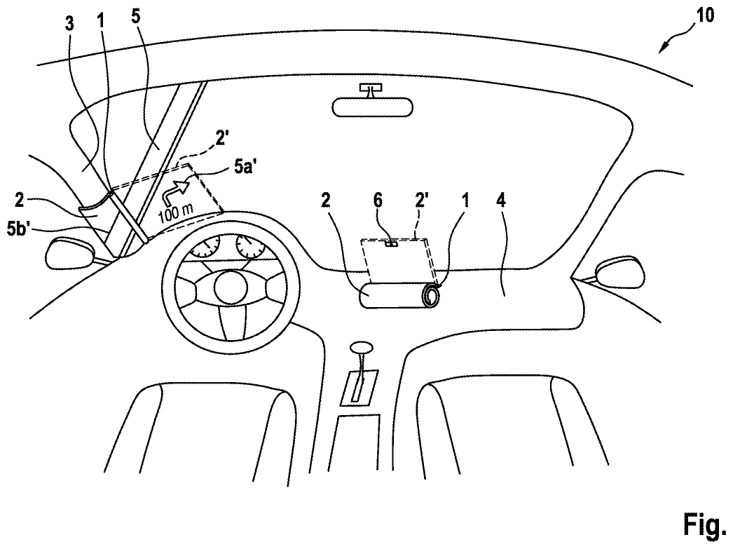

### CROSS-REFERENCE TO RELATED APPLICATIONS

The present application is the U.S. national phase of PCT Application No. PCT/EP2022/079330 filed on Oct. 20, 2022, which claims priority from German patent application no. 10 2021 131 343.0, filed on Nov. 30, 2021, the entire contents of which are incorporated herein by reference.

### FIELD

The present disclosure relates to a means of locomotion having a foldable or rollable display.

### BACKGROUND

Displays in means of locomotion for representing information, o (when configured as a touchscreen) for receiving user inputs, are known in the prior art. Entertainment functions as well as comfort and vehicle settings can be accessed via the displays.

Furthermore, the prior art now discloses initial approaches for foldable or rollable displays which offer a particularly innovative aspect ratio for portable mobile user terminals (for example tablets and smartphones). Such displays are, for example, presented in the following publication:
https://www.mib-terminal.de/produkte/video-walls/led-glas-transparent?gclid=CjwKCAjw3MSHBhB3EiwAxcaEu1KGiDHZTJhaCrG6KucGc1m6fbWSa1-T3j1R_aKVAvDb1wCh81T-FBoCh9kQAvD_BWE

### SUMMARY

In view of the foregoing, it would be desirable to adapt the representation of information in means of locomotion better to the requirements existing in the means of locomotion.

The means of locomotion (which may also be referred to herein as a “vehicle”) may for example be configured as an automobile, goods vehicle, motorcycle, truck, aircraft and/or watercraft. A base, or a holder, is arranged in a surface of an interior of the means of locomotion. The surface of the interior may for example be or comprise a dashboard, a center console, an A-pillar, a B-pillar, a roof lining, or the like. The base is adapted to hold a foldable or rollable display. In other words, the foldable or rollable display is set into the surface of the interior by means of the base, or is connected to this surface firmly and in particular stiffly. The ability of the display to roll or fold is not impeded by this attachment. Rather, the foldable or rollable display maintains its property of tilting or turning individual regions of the display or of the representation face in relation to other regions of the representation face, while for example covering or exceeding at least 90° in total with respect to the other regions. In particular, certain regions of the display may be turned or folded by approximately 180° or more. A first portion of the display may also be rolled or folded by for example 270°, 360° or 450° in relation to a second surface region of the display. This provides a particularly flexible arrangement of a display protruding from the surface of the interior of the means of locomotion, which enables flexible addressing of individual passengers as well as particularly crash-safe, i.e. pliant, provision of a representation face.

The base may have a lifting unit for lowering the display in the surface of the interior, or may interact with such a lifting unit. In other words, the base is either arranged in the lifting unit (or in its mobile portion) or else holds the lifting unit for lowering the display. In addition to the foldability or rollability, the display may therefore realize a further degree of freedom and optionally be lowered partially or fully in the surface. Alternatively, however, the display may also be held by the base rigidly, or in an immobile fashion, or in such a way that it can be turned. In other words, rotatability of the display about a horizontal and/or vertical axis may be provided. These additional degrees of freedom can also further increase the flexibility when using the display in the means of locomotion.

If the display is intended for a number of alternative users in the means of locomotion, measures may for example be taken so that digital information, by means of which the representation contents of the display can be modified, is generated during the folding or rolling. In other words, a first portion may be turned from a first relative position in relation to a second portion into a second relative position so that a sensor provides a signal representing the transition from the first position to the second position. The sensor signal may, for example, be interpreted as meaning that a different person now wishes to view the content of the display and, for example, an automatic variation of the display is desirable. For example, the first person may be sitting further away from the display than the second person, for which reason the representation content presented on the display may be adapted to the now altered viewing distance. For example, more and smaller details may be presented on the display, so that the second user is shown a larger text excerpt with a reduced font size than the first user was. The first position and the second position may also be predefined in such a way that different representation contents/information items are to be represented, since for example the first position is assigned to a driver/pilot of the means of locomotion, who might be interested in the representation of route-specific information, while a passenger occupying the second position wishes only to consume entertainment-specific contents since they cannot participate in the driving of the vehicle anyway. For example, when changing from the first position to the second position, a split-screen operating mode may therefore be turned on or off, scaling of the represented content may be increased or reduced, a content/representation content may be shifted in respect of the position where it is represented on the display, or additional information may be added or hidden. All this may take place automatically, and in particular as a function of a user-specifically performed configuration of the means of locomotion. Fewer operating steps are therefore desirable when turning the display from the first position to the second position, so that the user can concentrate more quickly on the traffic conditions.

If the representation content was modified when changing from the first position to the second position, the content previously represented in the first position may equally well be represented, or the operating mode may be started, when the display position is changed again to the first position. In other words, depending on the position of the display, there is a change between a first content assigned to the first position and a second content assigned to the second position, according to the respective position.

The display, or a sensor contained therein, may report the change from the first position to the second position. In response to the message (for example an electronic signal), an image generating unit (which may also be referred to as a head unit, graphics controller, or electronic control unit) may determine the respectively required representation content (in particular with the aid of a configuration file) and send it to the display. For example, a camera, an attitude sensor, a force sensor, a deformation sensor or any other suitable sensor may be used as a sensor that detects the change between the first position and the second position. For example, a light sensor or a microphone may also be used in order to adapt the representation content on the basis of modified transmission behavior. The respective sensor may for example be arranged in the housing of a display, or in the edge of the display. This provides a streamlined design and a compact module for permanent integration into the surface of the means of locomotion.

When rolling (rolling the display, or folding or turning or collapsing the display, is referred to in the context of the present embodiments, this means in particular a process in which the representation face of the display also at least partially leaves or reoccupies a common plane in which it has not previously been placed. For example, the display is curved, bent or retracted (twisted) in order at least partially to impart a different alignment than before to (one of) its surface normals. A particularly flexible and therefore crash-safe representation face may be provided in this way, since in the event of a collision it yields rapidly, without shattering and to a large extent, and collision therefore does not have such serious consequences as in the prior art.

For example, the display may be folded, rolled or retracted/curved in a motorized fashion. The motor may, in particular, be an electric motor and/or a piezoelectrically operating motor. In particular, a signal from a pre-crash safety system may be used in order to drive the motor or roll in or collapse the display, so as to present a silhouette/target area that is as small as possible for the event of a crash.

For example, the display may react quasi-automatically to a modified viewing situation, for example by a user who was previously viewing the display moving their eyes away from the display and, in response thereto, a part of the display or the entire display being aligned in a different direction inside the means of locomotion. For example, a projection area may in this case be maximized from the viewpoint of a second user by the normal to the display face being aligned in the direction of the second user. For example, an interior camera (particularly arranged in the display housing) or another sensor, or a voice processing system or another type of user interface may ascertain the fact that the second user would like to use the display at a second position. An either explicit or implicit request/input by the user may ensure that the display is aligned with their position. The same display face may therefore ergonomically be used by different positions in the means of locomotion. The sensors that the means of locomotion contains anyway for determining the person who currently has the greatest interest in viewing the display may be used for this, as may (as an alternative or in addition) sensors present in the display, or in the frame of the display, or in the housing of the display.

Depending on the position and particular application, the display may have dot-matrix representations on mutually opposite surfaces/sides, which can be switched between a first representation and a second representation, or an activated mode and a deactivated mode, according to the state of folding. For example, a display suspended in an A-pillar may enable the function of a (partially) transparent A-pillar in a state rolled around the A-pillar, by images taken with a camera being displayed on a first side of the rolled display, while in a second position, regions of a second (opposite) side of the display that lie in the primary or secondary field of view of the driver are output in order to display different types of information (for example route instructions/commands). The applications for a display according to the embodiments disclosed herein may be further increased in this way.

In order to further improve the crash safety in conjunction with a display according to embodiments disclosed herein, the display may have an airbag, which may in particular be arranged in an edge of the display and/or in a base of the display. In other words, an air-filled flexible bag may emerge/blow out from the edge and/or base, which in the event of a user striking the display distributes the resulting reciprocal forces and therefore improves the risk of injury to the user. The use of the airbag may likewise function on the basis of crash sensors or pre-crash sensors, the rolling function or folding function of the display being controllable as an alternative or in addition thereto in order to reduce the silhouette and the likelihood of injury.

### BRIEF DESCRIPTION OF THE DRAWING

Further details, features and advantages of the embodiments disclosed herein may be found in the following description and the figure. The figure shows a perspective representation of a driver's workplace of a means of locomotion configured according to the disclosure, with various displays according to the present disclosure.

The figure shows an automobile as a means of locomotion 10, in the dashboard 4 of which a first rollable display 2 is held by means of a base 1. The base 1 is arranged flush with the surface of the dashboard 4 and holds a lower portion of the display 2. In a first (deactivated or rolled-up) position, the display 2 is not arranged in the primary or secondary field of view of the user. In response to the display 2 being looked at, an actuator/motor can bring the display 2 into an upright position in which the display 2′ also aligns a camera 6 with the respective viewer. So long as the viewer is looking at the contents represented on the display 2 or 2′, the display 2 or 2′ can remain in the unfolded setting (represented by dashes). If the current viewer is no longer looking at the representation content, the display may be turned in a different direction, retracted or changed into the rolled-up configuration. Arranged on an A-pillar 3, there is also a second display 2, which follows the convex contour of the A-pillar 3 in order to provide a function that is also referred to as “transparent A-pillar”. In this position, a region of a curbstone 5 lying behind the A-pillar 3 is presented by a first side of the display 2 as representation content 5b′. A position of the representation content may in this case be presented by means of the camera 6 or by means of a different camera located in the interior of the means of locomotion 10. For this purpose, the position and alignment of the user's attention (not represented) may be determined and the external features (for example the curbstone 5) lying behind the A-pillar 3 may be captured by means of a front camera (not represented). The representation contents 5b′ may then be positioned, scaled and colored in such a way that they correspond to the curbstone 5 seen through the windshield. In a second position, turned in front of the bottom of the windshield, the display 2′ represented by dashes is used as a windshield bottom display, an opposite side of the display 2′ being used to represent navigation instructions 5a′ as representation contents. The navigation instructions 5a′ may be represented automatically in response to the display 2 being turned to the position of the display 2′, in response to which the representation content 5b′ is also deactivated in order to avoid reflections in the windshield. The turning may be carried out in a motorized fashion or manually. Further possible positions for displays 2 are the roof lining, the interior mirror or its base, the center console, the B-pillar, the C-pillar or, for example, headrests and backrests of the first or second row of seats.

### LIST OF REFERENCES

1 base
2, 2′ display
3 A-pillar
4 dashboard
5 curbstone
5a', 5b′ representation content
6 interior camera
10 means of locomotion

1.-11. (canceled)

12. A means of locomotion, comprising
a base; and
a foldable or rollable display;
wherein the base is arranged in a surface of an interior of the means of locomotion and holds the display.

13. The means of locomotion as claimed in claim 12, wherein the base:
has a lifting unit for lowering the display in the surface of the interior, or
holds the display rigidly or in such a way that it can be turned.

14. The means of locomotion as claimed in claim 13, wherein the display is adapted to turn a first portion from a first relative position in relation to a second portion into a second relative position and to vary a representation content automatically in response to the second position being reached.

15. The means of locomotion as claimed in claim 14, wherein the display is further adapted to represent a content previously represented in the first position once more in response to the first position being reached again from the second position.

16. The means of locomotion as claimed in claim 15, wherein the display is further adapted to emit a first signal to an graphics controller in response to a change from the first position to the second position or vice versa, in order to inform the electronic graphics controller of the change.

17. The means of locomotion as claimed in claim 16, wherein the display is adapted to generate the first signal by means of a camera and/or an attitude sensor and/or a force sensor or another sensor.

18. The means of locomotion as claimed in claim 17, wherein the turning comprises rolling in the display and/or collapsing the display, in particular about an axis contained in the display.

19. The means of locomotion as claimed in claim 16, wherein the display is adapted to be rolled in or folded in response to a second signal representing an imminent crash of the means of locomotion.

20. The means of locomotion as claimed in claim 19, wherein the display is adapted to change from a rolled-in state to an unrolled state or from a folded state to an unfolded state, or vice versa, in response to a third signal of a camera or of another sensor or of a user interface.

21. The means of locomotion as claimed in claim 16, wherein the display has a representation face in the manner of a dot-matrix representation on a front side and on a rear side, which are adapted to represent different representation contents independently of one another.

22. The means of locomotion as claimed in claim 21, wherein the display further has an airbag, which is deployed in the event of a crash.

23. A vehicle comprising:
an interior surface of the vehicle;
a display holder positioned on the interior surface; and
a moveable display positioned on the display holder, wherein the display is adapted to turn a first portion from a first position in relation to a second portion into a second position and to vary a representation content automatically in response to the second position being reached.

24. The vehicle of claim 23 wherein the display holder includes a lifting unit for lowering the display on the interior surface.

25. The vehicle of claim 23 wherein the turning from the first position to the second position comprises movement about an axis defined by the display.

26. The vehicle of claim 23 wherein the display is further adapted to emit a first signal to a graphics controller in response to a change from the first position to the second position or vice versa, in order to inform the graphics controller of the change.

27. The vehicle of claim 26 wherein the display is adapted to be moved in response to a second signal representing an imminent crash of the vehicle.

28. The vehicle of claim 27 wherein the display is adapted to be rolled in or folded in response to the second signal, and wherein the display is adapted to change from a rolled-in state to an unrolled state or from a folded state to an unfolded state, or vice versa, in response to a third signal of a camera or of another sensor or of a user interface.

29. The vehicle of claim 27 wherein the display further has an airbag, which is deployed in the event of the imminent crash.

30. The vehicle of claim 23 wherein the interior surface includes a dashboard, a center console, an A-pillar, a B-pillar, or a roof lining of the vehicle.

31. A vehicle comprising:
an interior surface of the vehicle;
a display holder positioned on the interior surface; and
a foldable or rollable display positioned on the display holder, wherein the display is adapted to be folded or rolled in response to a second signal representing an imminent crash of the vehicle, the display further including an airbag configured to be deployed in the event of the imminent crash.
